(19) United States
(12) Patent Application Publication
(10) Pub. No.: US 2018/0095615 A1
(43) Pub. Date: Apr. 5, 2018

(54) Interactive Information Presentation System and Method

(71) Applicant: Gen 1 Media Group, Inc., Pittsburgh, PA (US)

(72) Inventors: Christine Martier, Pittsburgh, PA (US); Reynold Yordy, Thompsons Station, TN (US)

(21) Appl. No.: 15/722,518

(22) Filed: Oct. 2, 2017

Related U.S. Application Data
(60) Provisional application No. 62/403,398, filed on Oct. 3, 2016.

(51) Int. Cl. G06F 3/0482; G06K 15/00; H04N 21/214; G06F 17/30

(52) U.S. Cl. CPC G06F 3/0482; G06F 17/30029; H04N 21/2143; G06K 15/007

(57) ABSTRACT

Disclosed is an interactive information presentation system and method for use by a host service provider and interaction by at least one guest user in a target setting. The system includes a public display device controller programmed or configured to cause at least one public display device to display at least a portion of media content. The system also includes at least one user display device programmed or configured to receive user input and display at least a portion of the media content. The system further includes a media server programmed or configured to receive media content lists, download the media content, and distribute the media content over a local network. The system further includes a media playlist creation system configured to communicate and store media content information. The system further includes a data management system configured to communicate and store system operation data.

### BACKGROUND OF THE INVENTION

### Field of the Invention

Disclosed embodiments relate generally to data and information display systems, and in particular, to a system and method of presenting information in an interactive format for one or more users in a target setting.

### Description of Related Art

There are many situations where one's guests or clients must wait in a target setting, e.g., a waiting room, a queue, a lobby, and/or the like, usually in anticipation of receiving the host's services. Often, guests are provided (or self-provide) various forms of media to entertain, distract, educate, or inform the guests while they are waiting to be served. A common example of such a setting is a patient waiting room in a doctor's office, where more often than not, wait times exceed twenty minutes or more. Patients may be provided with posters, televisions, magazines, books, and/or the like while they are waiting to see a physician. Perhaps more likely, a consumer may use a personal portable device, such as a smartphone or a tablet, to self-entertain. These disparate forms of media all have the common trait of individual consumption and interaction, whereby the user must gather their own media resources and seek out information. This can be inefficient, time-consuming, or boring to the guest, and it is difficult for a guest to provide feedback on their waiting experience. Moreover, non-digital media, such as magazines, brochures, or posters, can become quickly outdated, and if not replaced, may become inaccurate and misinform a consumer. Finally, the host service provider, e.g., a physician or medical office, may find it difficult to provide service or advertising information to the consumer, such that a user will both see and internalize the information.

There is a need in the art to provide targeted, up-to-date, and relevant information to a user, wherein the various sources of information are combined and available in one or more media, and the consumer can interact with content they did not have to resource themselves. There is also a need in the art to provide such information through more than one medium at a time, such that the media is related or synchronized for presentation to end users.

### SUMMARY OF THE INVENTION

Generally, provided is a system and method for interactive information presentation, for use by a host service provider and interaction by at least one guest user in a target setting. Preferably, the system includes at least one public display device controller and at least one user display device configured to synchronously present media content. Preferably, the system includes a media server, a media playlist creation system, and a data management system. Preferably, the system includes a local networking device.

According to one preferred and non-limiting embodiment or aspect, provided is an interactive information presentation system for use by a host service provider and interaction by at least one guest user in a target setting. The system includes a public display device controller programmed or configured to communicate with at least one public display device and cause the at least one public display device to display at least a portion of media content. The media content includes at least one of the following: video data, audio data, advertisements, host service provider information, regional information, or any combination thereof. The system also includes at least one user display device programmed or configured to receive user input and display at least a portion of the media content customized to the at least one user display device. The system further includes a media server programmed or configured to receive media content lists, download the media content, and distribute the media content over a local network. The system further includes a media playlist creation system that includes a processor and a database configured to communicate and store media content information, respectively. The media content information includes at least one of the following: links to video assets, data to categorize and identify the media content, media playlist parameters, logs of playback of the media content, or any combination thereof. The system further includes a data management system, which includes a processor and a database configured to communicate and store system operation data, respectively. The system operation data includes at least one of the following: customer data, advertisement data, or any combination thereof.

In further preferred and non-limiting embodiments or aspects, the system may include a local networking device that is programmed or configured to facilitate the local network for intercommunication by the public display device, the at least one user display device, and the media server device. The local networking device may be further programmed or configured to provide intercommunication by the media playlist creation system, the data management system, and devices communicating in the local network. The system may include a first public display device having at least one data input and being programmed or configured to communicate with the public display device controller. The local networking device may be programmed or configured to facilitate multicast network traffic for communicating the media content to the at least one user display device and the public display device controller for synchronized display to the at least one guest user.

In further preferred and non-limiting embodiments or aspects, the at least one user display device may be a first user display device and a second user display device. The first user display device may be programmed or configured to display the media content customized to a first guest user of the at least one guest user. The second user display device may be programmed or configured to display the media content customized to a second guest user of the at least one guest user. Further, the first user display device and the second user display device may be different types of devices selected from a first model of tablet computer, a second model of tablet computer, and a smartphone. The media content may include a first set of advertisements customized for display on the first user display device to the first guest user and a second set of advertisements customized for display on the second user display device to the second guest user.

In further preferred and non-limiting embodiments or aspects, the at least one user display device and the public display device controller may communicate to the data management system data representative of display of and user interaction with the media content by the at least one guest user. The data management system may communicate to a system administrator the data representative of display of and user interaction with the media content. Further, the media content may include at least one video and audio segment, the video and audio segment being selected to represent services provided by the host service provider.

In further preferred and non-limiting embodiments or aspects, the data management system may be programmed or configured to receive a first device identifier and first request for media content from a first user display device of the at least one user display device, and determine an identity of the first user display device based at least partially on the first device identifier. The data management system may be programmed or configured to receive a second device identifier and a second request for media content from the public display device controller, and determine an identity of the public display device controller based at least partially on the second device identifier. The data management system may be programmed or configured to determine the media content for display through the first user display device and the public display device controller, and receive a list of media content and a corresponding playlist from a media playlist creation system and provide the list of media content and the corresponding playlist to the media server for creation of a synchronized multicast data object. The multicast data object may include the media content and be configured to display the media content. The data management system may be programmed or configured to, in response to determining the media content for display, communicate the media content to the first user display device and the public display device controller, at least partially through a local network, the media content being configured for synchronized display on the first user display device and the at least one public display device to the at least one guest user.

According to one preferred and non-limiting embodiment or aspect, provided is an interactive information presentation method for use by a host service provider and interaction by at least one guest user in a target setting. The method includes receiving a first device identifier and first request for media content from at least one user display device. The at least one user display device is programmed or configured to receive user input and display at least a portion of media content. The method also includes determining an identity of the at least one user display device based at least partially on the first device identifier. The method further includes receiving a second device identifier and a second request for media content from a public display device controller. The public display device controller is programmed or configured to communicate with at least one public display device and cause the at least one public display device to display at least a portion of the media content. The method further includes determining an identity of the public display device controller based at least partially on the second device identifier. The method further includes determining the media content for display through the at least one user display device and the public display device controller. The method further includes receiving a list of media content and a corresponding playlist from a media playlist creation system and providing the list of media content and the corresponding playlist to a media server for creation of a synchronized multicast data object that includes the media content and is configured to display the media content. The method further includes, in response to determining the media content for display, communicating the media content to the at least one user display device and the public display device controller, at least partially through a local network, the media content being configured for synchronized display on the at least one user display device and the at least one public display device to the at least one guest user.

In further preferred and non-limiting embodiments or aspects, the media content includes advertisements customized for display to the at least one guest user. The method may include receiving data representative of display of and user interaction with the media content by the at least one guest user through the at least one user display device and the public display device controller. The method may further include reporting the data to at least one system administrator. The media content may further include at least one video and audio segment, the video and audio segment being selected to represent services provided by the host service provider. The method may further include communicating the media content to the at least one user display device and the public display device controller indirectly through the media server.

According to one preferred and non-limiting embodiment or aspect, provided is an apparatus for an interactive information presentation system of a host service provider supporting at least one guest user in a target setting, the apparatus includes at least one non-transitory computer-readable medium having program instructions stored thereon. The program instructions, when executed by at least one processor, cause the at least one processor to receive a first device identifier and first request for media content from at least one user display device, the at least one user display device being programmed or configured to receive user input and display at least a portion of media content. The program instructions also cause the at least one processor to determine an identity of the at least one user display device based at least partially on the first device identifier. The program instructions further cause the at least one processor to receive a second device identifier and a second request for media content from a public display device controller, the public display device controller being programmed or configured to communicate with at least one public display device and cause the at least one public display device to display at least a portion of the media content. The program instructions further cause the at least one processor to determine an identity of the public display device controller based at least partially on the second device identifier. The program instructions further cause the at least one processor to determine the media content for display through the at least one user display device and the public display device controller. The program instructions further cause the at least one processor to receive a list of media content and a corresponding playlist from a media playlist creation system and provide the list of media content and the corresponding playlist to a media server for creation of a synchronized multicast data object. The multicast data object includes the media content and is configured to display the media content. The program instructions further cause the at least one processor to, in response to determining the media content for display, communicate the media content to the at least one user display device and the public display device controller, at least partially through a local network, the media content being configured for synchronized display on the at least one user display device and the at least one public display device to the at least one guest user.

In further preferred and non-limiting embodiments or aspects, the media content may include advertisements customized for display to the at least one guest user. The program instructions may cause the at least one processor to receive data representative of display of and user interaction with the media content by the at least one guest user through the at least one user display device and the public display device controller. The program instructions may also cause the at least one processor to report the data to at least one system administrator. The media content may further include at least one video and audio segment, the video and audio segment being selected to represent services provided by the host service provider. The program instructions may further cause the at least one processor to communicate the media content to the at least one user display device and the public display device controller indirectly through the media server.

Other preferred and non-limiting embodiments or aspects of the present invention will be set forth in the following numbered clauses:

Clause 1: An interactive information presentation system for use by a host service provider and interaction by at least one guest user in a target setting, the system comprising: a public display device controller programmed or configured to communicate with at least one public display device and cause the at least one public display device to display at least a portion of media content, the media content comprising at least one of the following: video data, audio data, advertisements, host service provider information, regional information, or any combination thereof; at least one user display device programmed or configured to receive user input and display at least a portion of the media content customized to the at least one user display device; a media server programmed or configured to receive media content lists, download the media content, and distribute the media content over a local network; a media playlist creation system comprising a processor and a database configured to communicate and store media content information, respectively, the media content information comprising at least one of the following: links to video assets, data to categorize and identify the media content, media playlist parameters, logs of playback of the media content, or any combination thereof; and a data management system comprising a processor and a database configured to communicate and store system operation data, respectively, the system operation data comprising at least one of the following: customer data, advertisement data, or any combination thereof.

Clause 2: The system of clause 1, further comprising a local networking device programmed or configured to facilitate the local network for intercommunication by the public display device, the at least one user display device, and the media server device, the local networking device being further programmed or configured to provide intercommunication by the media playlist creation system, the data management system, and devices communicating in the local network.

Clause 3: The system of clauses 1 or 2, further comprising a first public display device having at least one data input and being programmed or configured to communicate with the public display device controller.

Clause 4: The system of any of clauses 1-3, wherein the local networking device is programmed or configured to facilitate multicast network traffic for communicating media content to the at least one user display device and the public display device controller for synchronized display to the at least one guest user.

Clause 5: The system of any of clauses 1-4, wherein the at least one user display device is a first user display device and a second user display device, the first user display device being programmed or configured to display the media content customized to a first guest user of the at least one guest user, and the second user display device being programmed or configured to display the media content customized to a second guest user of the at least one guest user.

Clause 6: The system of any of clauses 1-5, wherein the first user display device and the second user display device are different types of devices selected from a first model of tablet computer, a second model of tablet computer, and a smartphone.

Clause 7: The system of any of clauses 1-6, wherein the media content comprises a first set of advertisements customized for display on the first user display device to the first guest user and a second set of advertisements customized for display on the second user display device to the second guest user.

Clause 8: The system of any of clauses 1-7, wherein the at least one user display device and the public display device controller communicate to the data management system data representative of display of and user interaction with the media content by the at least one guest user, and wherein the data management system communicates to a system administrator the data representative of display of and user interaction with the media content.

Clause 9: The system of any of clauses 1-8, wherein the media content comprises at least one video and audio segment, the video and audio segment being selected to represent services provided by the host service provider.

Clause 10: The system of any of clauses 1-9, wherein the data management system is programmed or configured to: receive a first device identifier and first request for media content from a first user display device of the at least one user display device; determine an identity of the first user display device based at least partially on the first device identifier; receive a second device identifier and a second request for media content from the public display device controller; determine an identity of the public display device controller based at least partially on the second device identifier; determine the media content for display through the first user display device and the public display device controller; receive a list of media content and a corresponding playlist from a media playlist creation system and provide the list of media content and the corresponding playlist to the media server for creation of a synchronized multicast data object, comprising the media content and configured to display the media content; and, in response to determining the media content for display, communicate the media content to the first user display device and the public display device controller, at least partially through a local network, the media content being configured for synchronized display on the first user display device and the at least one public display device to the at least one guest user.

Clause 11: An interactive information presentation method for use by a host service provider and interaction by at least one guest user in a target setting, the method comprising: receiving a first device identifier and first request for media content from at least one user display device, the at least one user display device being programmed or configured to receive user input and display at least a portion of media content; determining an identity of the at least one user display device based at least partially on the first device identifier; receiving a second device identifier and a second request for media content from a public display device controller, the public display device controller being programmed or configured to communicate with at least one public display device and cause the at least one public display device to display at least a portion of the media content; determining an identity of the public display device controller based at least partially on the second device identifier; determining the media content for display through the at least one user display device and the public display device controller; receiving a list of media content and a corresponding playlist from a media playlist creation system and providing the list of media content and the corresponding playlist to a media server for creation of a synchronized multicast data object comprising the media content and configured to display the media content; and, in response to determining the media content for display, communicating the media content to the at least one user display device and the public display device controller, at least partially through a local network, the media content being configured for synchronized display on the at least one user display device and the at least one public display device to the at least one guest user.

Clause 12: The method of clause 11, wherein the media content comprises advertisements customized for display to the at least one guest user.

Clause 13: The method of clauses 11 or 12, further comprising: receiving data representative of display of and user interaction with the media content by the at least one guest user through the at least one user display device and the public display device controller; and reporting the data to at least one system administrator.

Clause 14: The method of any of clauses 11-13, wherein the media content further comprises at least one video and audio segment, the video and audio segment being selected to represent services provided by the host service provider.

Clause 15: The method of any of clauses 11-14, further comprising communicating the media content to the at least one user display device and the public display device controller indirectly through the media server.

Clause 16: An apparatus for an interactive information presentation system of a host service provider supporting at least one guest user in a target setting, the apparatus comprising at least one non-transitory computer-readable medium having program instructions stored thereon that, when executed by at least one processor, cause the at least one processor to: receive a first device identifier and first request for media content from at least one user display device, the at least one user display device being programmed or configured to receive user input and display at least a portion of media content; determine an identity of the at least one user display device based at least partially on the first device identifier; receive a second device identifier and a second request for media content from a public display device controller, the public display device controller being programmed or configured to communicate with at least one public display device and cause the at least one public display device to display at least a portion of the media content; determine an identity of the public display device controller based at least partially on the second device identifier; determine the media content for display through the at least one user display device and the public display device controller; receive a list of media content and a corresponding playlist from a media playlist creation system and provide the list of media content and the corresponding playlist to a media server for creation of a synchronized multicast data object comprising the media content and configured to display the media content; and, in response to determining the media content for display, communicate the media content to the at least one user display device and the public display device controller, at least partially through a local network, the media content being configured for synchronized display on the at least one user display device and the at least one public display device to the at least one guest user.

Clause 17: The apparatus of clause 16, wherein the media content comprises advertisements customized for display to the at least one guest user.

Clause 18: The apparatus of clauses 16 or 17, further causing the at least one processor to: receive data representative of display of and user interaction with the media content by the at least one guest user through the at least one user display device and the public display device controller; and report the data to at least one system administrator.

Clause 19: The apparatus of any of clauses 16-18, wherein the media content further comprises at least one video and audio segment, the video and audio segment being selected to represent services provided by the host service provider.

Clause 20: The apparatus of any of clauses 16-19, further causing the at least one processor to communicate the media content to the at least one user display device and the public display device controller indirectly through the media server.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic diagram of one embodiment or aspect of an interactive information presentation system, according to the principles of the present invention;

FIG. 2 is a process diagram of setting up the interactive information presentation system, according to the principles of the present invention;

FIG. 3 is a process diagram for the on-site workflow of the system, according to the principles of the present invention;

FIG. 4 is a process diagram for the communication flow of a subset of elements of the system, according to the principles of the present invention;

FIG. 5 is a process diagram for the initialization of an element of the system, according to the principles of the present invention;

FIG. 6. is a process diagram for the communication flow of a subset of elements of the system, according to the principles of the present invention;

FIG. 7 is a process diagram for the communication flow of a subset of elements of the system, according to the principles of the present invention;

FIG. 8 is a process diagram for the communication flow of a subset of elements of the system, according to the principles of the present invention; and,

FIG. 9 is a mockup of a user display device for use in the system, according to the principles of the present invention.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and process illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt, transmission, or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc., between the first and second unit or device. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. It will be appreciated that numerous other arrangements are possible. Any known electronic communication protocols and/or algorithms may be used such as, for example, TCP/IP (including HTTP and other protocols), WLAN (including 802.11 and other radio frequency-based protocols and methods), analog transmissions, Global System for Mobile Communications (GSM), and/or the like.

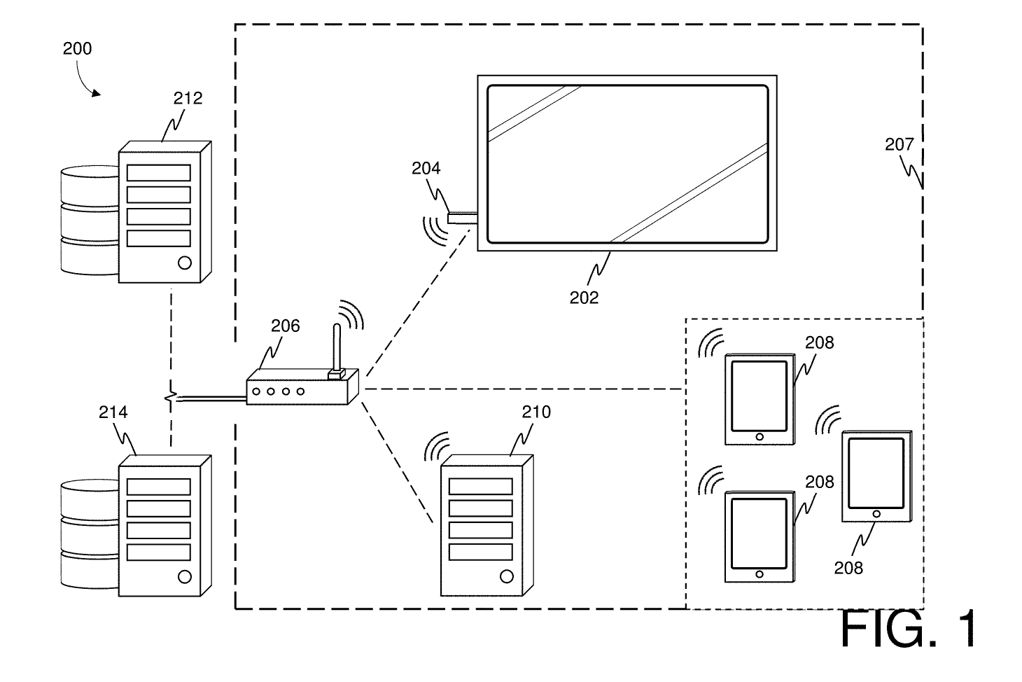

With specific reference to FIG. 1, and in one preferred and non-limiting embodiment or aspect, provided is a system 200 for synchronously and interactively presenting information to one or more users in a target setting, e.g., a waiting room, a queue, a lobby, a restaurant, and/or the like. The type of information presented may vary, but preferred embodiments are configured to present media content, such as video content (e.g., slideshows, broadcast media programs, tutorials, etc.), audio content (e.g., music, radio broadcast, recorded voiceover, etc.), graphic content, informative text, advertisements, and/or the like. The system 200 may include or make use of a public display device 202, e.g., a television, a computer monitor, a digital poster, and/or the like, the public display device 202 being programmed or configured to display media content and interface with the system's 200 public display device controller 204. The controller 204 is programmed or configured to communicate to the public display device 202 through an electronic connection, wireless communication, or other similar means. One example combination of public display device 202 and controller 204 is a television, having one or more data input ports, and a plug-in processor with local memory and a wireless transceiver, such as a wi-fi enabled HDMI or USB stick running an Android operating system. It will be appreciated that many other configurations and embodiments are possible. The system 200 may further include or make use of a local networking device 206, e.g., a wireless Internet router, to facilitate a local network 207 and manage network traffic such that devices in the target setting can communicate with each other. The local networking device 206 is also programmed or configured to facilitate multicast network traffic, such as by communicating with devices in the local network 207 using a transport layer protocol such as User Datagram Protocol (UDP) multicast. The local network 207 is preferably a wireless communication network, such as a wi-fi network, but it will be appreciated that other configurations are possible.

With further reference to FIG. 1, and in a further preferred and non-limiting embodiment or aspect, the system 200 may include one or more user display devices 208, e.g., tablet computers, laptop computers, desktop computers, smartphones, and/or the like, to display media content to one or more users. The user display devices 208 are programmed or configured to both display media content and receive user input, providing a user interface. A preferred embodiment of a user display device 208 is a tablet computer running an Android operating system, but it will be appreciated that other configurations are possible. The user display devices 208 may be programmed or configured to communicate with other devices in the local network 207 either directly or indirectly, such as through the local networking device 206. Preferably, the devices of the local network 207 communicate with each other via password-protected wi-fi. The system 200 also includes a media server 210, which may be one or more processors or computers with a local memory, such as RAM or a database, that is programmed or configured to communicate with the local networking device 206 and/or other devices in the local network 207. A preferred embodiment of the media server 210 is a Linux (Ubuntu) based media server, such as Plotter software by Wowza, but it will be appreciated that other configurations or programs are possible. The media server 210 is programmed or configured to receiving media content playlists, download the media content therein, and distribute media content within the local network 207, such as by video stream. Other configurations or arrangements are possible.

With further reference to FIG. 1, and in a further preferred and non-limiting embodiment or aspect, the system 200 further includes a media playlist creation system 212, which may be one or more processors or computers with a local memory, such as RAM or a database. The media playlist creation system 212 is programmed or configured to communicate with the media server 210 directly or indirectly via the local networking device 206. In a preferred embodiment, the media playlist creation system 212 is a server computer running a web-based (Linux/Apache/MySQL/Java) video broadcast application that is communicatively connected to the media server 210 via a wireless router's wired Internet connection. It will be appreciated that other systems, programs, and configurations are possible. The media playlist creation system 212 may be further programmed or configured to receive video content assets for cataloging media content and creating media playlists. The media playlist creation system 212 may be programmed or configured to store: media content; media playlist parameters; links to video assets; data to categorize and identify content; playlist definitions that include media content identification and ordering; and/or logs of what media has been displayed, and when. Other configurations or arrangements are possible.

With further reference to FIG. 1, and in a further preferred and non-limiting embodiment or aspect, the system 200 further includes a data management system 214, which may be one or more processors or computers with a local memory, such as RAM or a database. The data management system 214 is programmed or configured to communicate to the media server 210 directly or indirectly via the local networking device 206. In a preferred embodiment, the data management system 214 is a server computer running a web-based (Linux/Apache/MySQL/PHP) Customer and Content Management System (CCMS) that is communicatively connected to the media server 210 via a wireless router's wired Internet connection. It will be appreciated that other systems, programs, and configurations are possible. The data management system 214 may be further programmed or configured to store customer (e.g., user) profiles as well as advertising distribution parameters regarding which locations and users will receive which media content. The data management system 214 may be further programmed or configured to store: location data, including media throughput and waiting room size; customer data, including contacts and promotional assets, which may be graphical and/or textual; advertisement data, including contacts and assets, which may be graphical and/or textual; advertisement targeting parameters, including host specialties, customer customization data, geographic data, demographic data, and/or time-based parameters; and, log data, including which devices have displayed which content and when, and which links end users interacted with, further including anonymized demographics, if provided to the data management system 214. It will also be appreciated that the system 200 may integrate with a service provider's customer information database (not shown), such as an electronic medical records (EMR) system. Data provided to users and collected from users may be stored and updated in the service provider's customer information database. Other configurations or arrangements are possible.

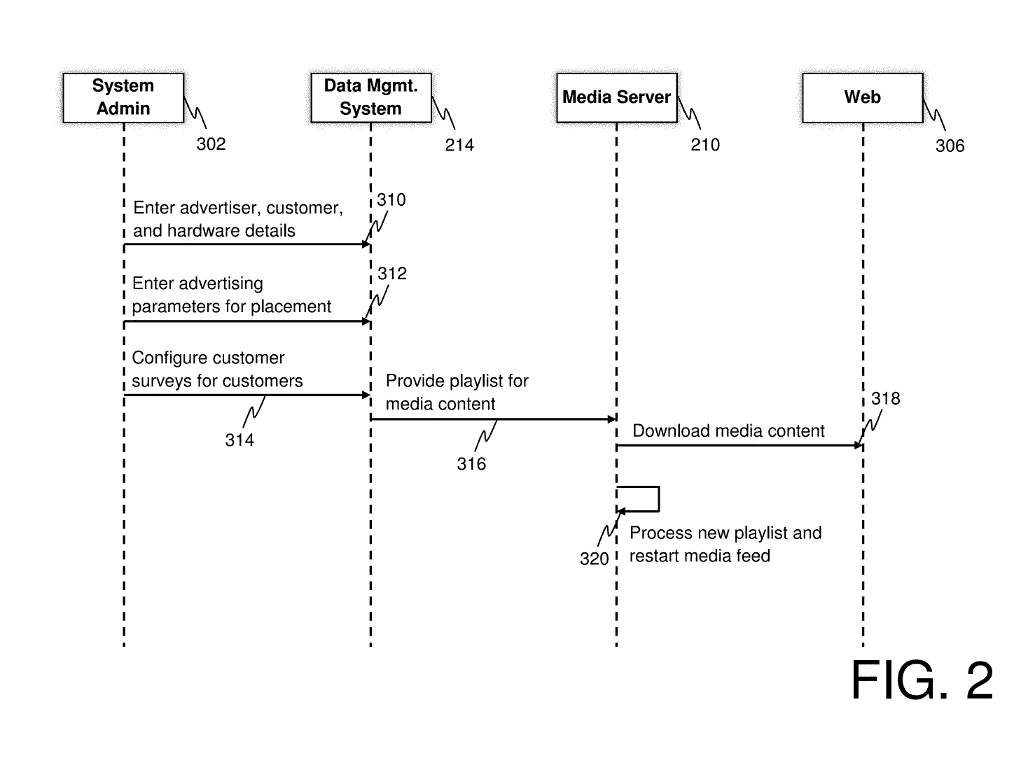

With specific reference to FIG. 2, and in one preferred and non-limiting embodiment or aspect, provided is a process diagram of setting up the interactive information presentation system 200. The process includes interactions between a system admin 302, the data management system 214, the media server 210, and web-based assets 306. The system admin 302 may include personnel or automated processes related to administration of the system 200. At step 310, the system admin 302 enters advertiser, customer, and hardware details into the data management system 214. At step 312, the system admin 302 enters into the data management system 214 advertising parameters for the placement of advertisements, which may include: designated market areas, zip codes, location types, parent companies, location data, consumer demographics, and/or the like. At step 314, the system admin 302 configures customer surveys for end users and stores the surveys in the data management system 214. Next, at step 316, the media playlist creation system 212 (not shown) transfers one or more playlists of media content to the data management system 214, which subsequently transmits one or more playlists of media content to the media server 210. Based on a provided playlist in step 316, at step 318 the media server 210 downloads media content, e.g., videos, from their sources, which are preferably web-based assets 306, but other arrangements are possible. At step 320, the media server then processes the one or more new playlists and restarts the media feed, such as initiating the first video in the first playlist. It will be appreciated that other configurations are possible.

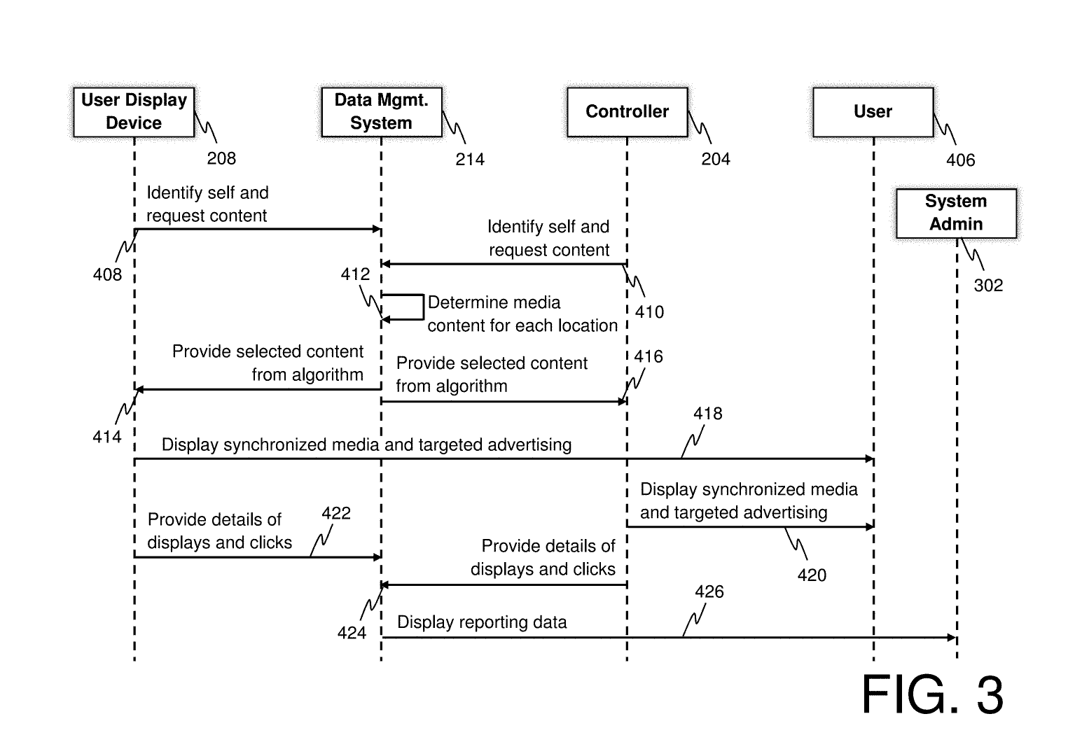

With specific reference to FIG. 3, and in one preferred and non-limiting embodiment or aspect, provided is a process diagram for the on-site workflow of the system 200 as it operates in a target setting, such as the waiting room of a physician's office. The process includes interactions between a user display device 208, the data management system 214, a public display device controller 204, a user 406, and a system admin 302. It will be appreciated that this process may involve more than one user display device 208, controller 204, and/or user 406. At step 408, the user display device 208 provides identifying data to the data management system 214 and requests media content. At step 410, the controller 204, which controls the operations of a public display device 202, also provides identifying data to the data management system 214 and requests media content. At step 412, the data management system 214 determines the media content, preferably by a predetermined set of parameters and/or algorithm, for each location, namely, each user display device 208 and each public display device controller 204 at each target setting. After step 412, the data management system 214 provides the selected media content to each location, including the user display device 208 in step 414 and the controller 204 in step 416. After receiving the selected content, the user display device 208 displays the media, including any targeted advertising, to the user 406, in step 418. Likewise, in step 420, the controller 204 displays the provided media content to the user 406, including any targeted advertising. Preferably, the media displayed by the user display device 208 is synchronized with the media displayed by the controller 204. In step 422, the user display device 208 provides details of displays and clicks of media and advertisements to the data management system 214. Similarly, in step 424, the controller 204 provides details of displays and clicks of media and advertisements to the data management system 214. In step 426, the data management system 214 reports the displays and click data back to the system admin 302, preferably configured for display to a system admin 302 personnel. It will be appreciated that other configurations are possible.

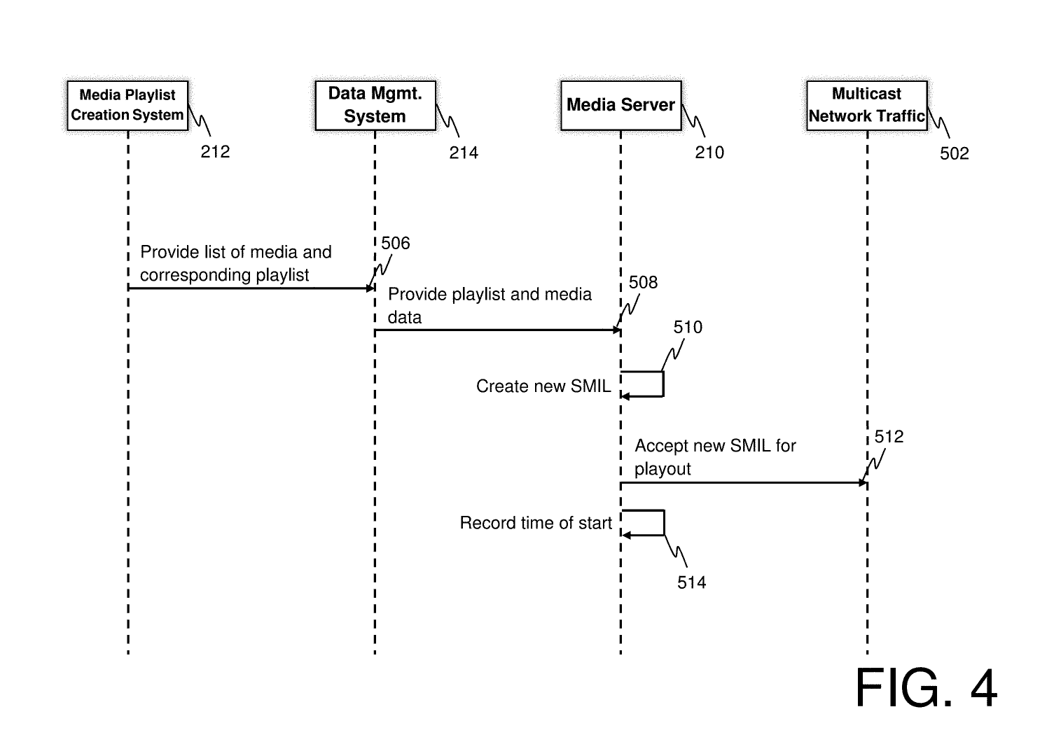

With specific reference to FIG. 4, and in one preferred and non-limiting embodiment or aspect, provided is a process diagram for the communication flow of the system 200 between the media playlist creation system 212, the data management system 214, the media server 210, and multicast network traffic 502, which is preferably facilitated by the local networking device 206. In step 506, the media playlist creation system 212 provides a list of media and a corresponding playlist to the data management system 214. The media is preferably video content, but other media may be used in the process. The data management system 214, in step 508, then communicates with the media server 210, providing playlist and media data. The media server 210, in step 510, then formats the playlist and media data in a multicast data object, such as a Synchronized Multimedia Integration Language (SMIL) object. The media server 210, in step 512, communicates the multicast data object at least partially within the local network, which facilitates the multicast network traffic 502, for multicast to one or more user display device 208 and one or more public display device controller 204. The media server 210, in step 514, records the time of start of the media multicast. It will be appreciated that other configurations are possible.

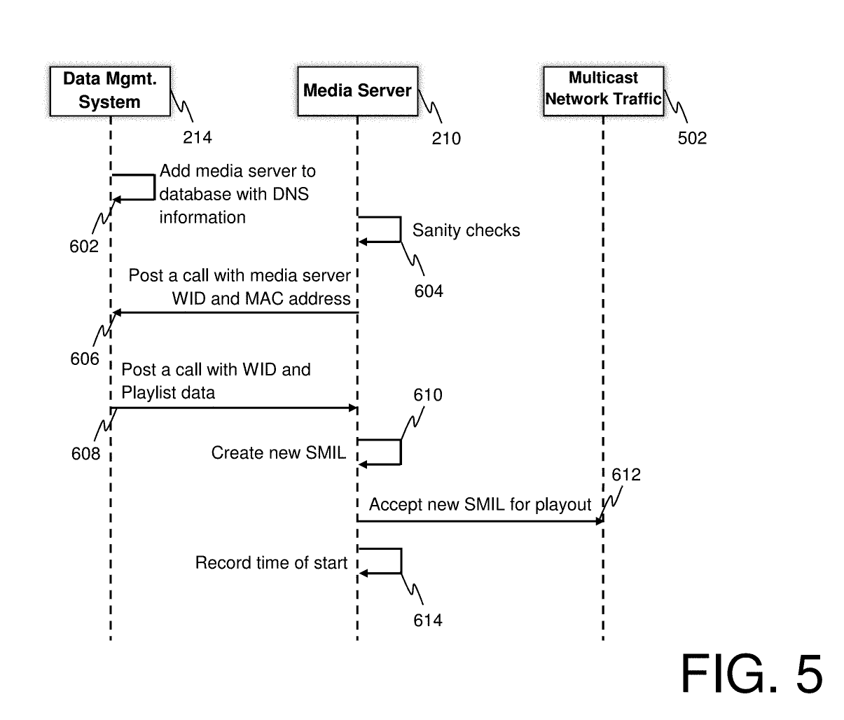

With specific reference to FIG. 5, and in one preferred and non-limiting embodiment or aspect, provided is a process diagram for the initialization of the media server 210 of the system 200. The initialization process includes communication between the data management system 214, the media server 210, and multicast network traffic 502, preferably facilitated by the local networking device 206. In step 602, the data management server adds the media server to its database with the relevant system and network identification information. In step 604, the media server 210 runs initialization testing, preferably through programmatic sanity checks. In step 606, the media server 210 posts a call to the data management system 214 with its media server 210 universal unique identifier (UUID) and media access control (MAC) address. In step 608, the data management system 214 posts a call to the media server 210 with its UUID and MAC address. In step 610, the media server 210 creates a new multicast data object, and in step 612 the multicast data object is provided for playout at least partly within the local network, which facilitates the multicast network traffic 502. In step 614, the media server 210 records the time of start of the media multicast. It will be appreciated that other configurations are possible.

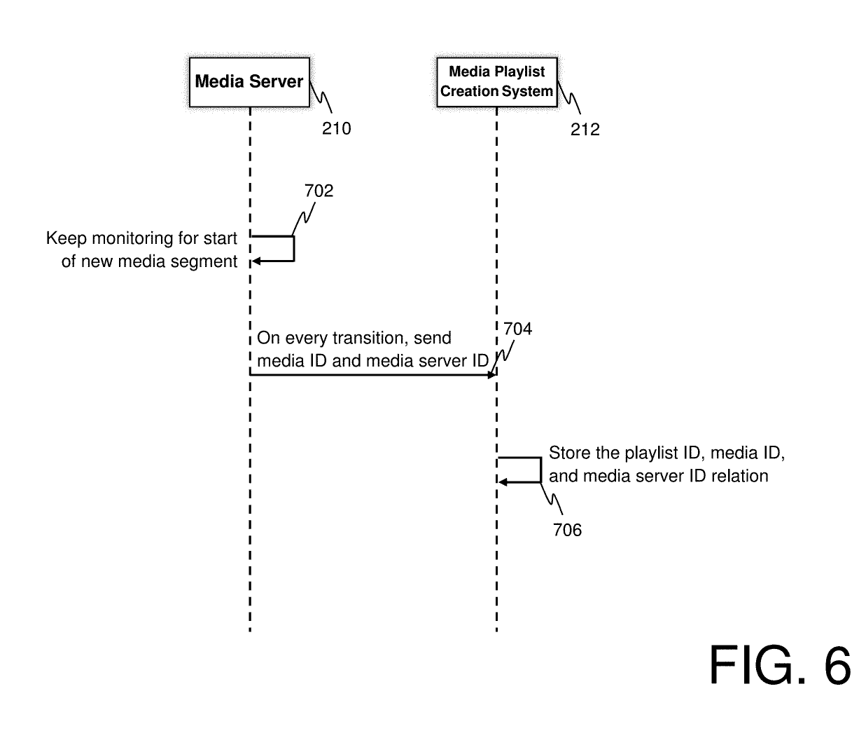

With specific reference to FIG. 6, and in one preferred and non-limiting embodiment or aspect, provided is a process diagram for the communication flow between the media server 210 and the media playlist creation system 212 of the system 200. In step 702, the media server 210 continuously monitors for the start of a new media segment, such as the start of a new video in the playlist. In step 704, the media server 210 communicates to the media playlist creation system 212, on every transition between media segments, the media ID and the media server 210 ID. In step 706, the media playlist creation system 212 stores the data relationship, such as the grouping, of the playlist ID, the media ID, and the media server 210 ID. It will be appreciated that other configurations are possible.

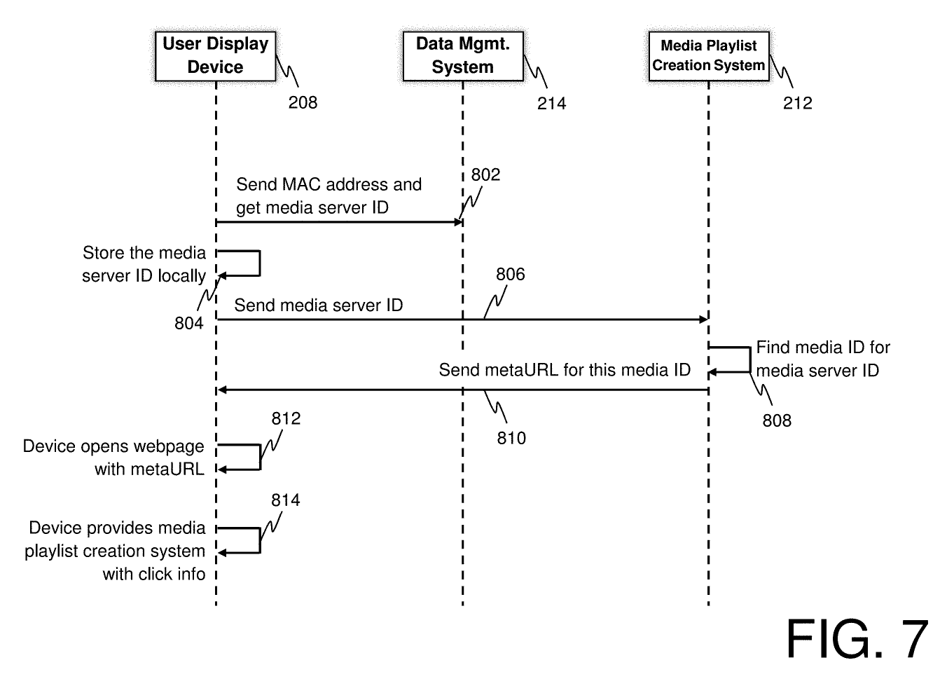

With specific reference to FIG. 7, and in one preferred and non-limiting embodiment or aspect, provided is a process diagram for the communication flow of the system 200 between a user display device 208, the data management system 214, and the media playlist creation system 212. It will be appreciated that the process may include one or more user display devices 208. At step 802, the user display device 208 sends its MAC address to the data management system 214 and receives the media server 210 ID. At step 804, the user display device 208 stores the media server ID in local memory. At step 806, the user display device 208 provides the media server ID to the media playlist creation system 212. At step 808, the media playlist creation system 212 finds a corresponding media ID for the given media server 210 ID. At step 810, the media playlist creation system 212, preferably in response to a programmatic method call, communicates a web address, such as a metaURL, for the identified media ID. At step 812, the user display device 208 opens the webpage associated with the given web address, which it may do continuously based on the meta refresh attribute of the webpage. At step 814, the user display device 208 reports click info to the media playlist creation system 212, which it may also do continuously. It will be appreciated that other configurations are possible.

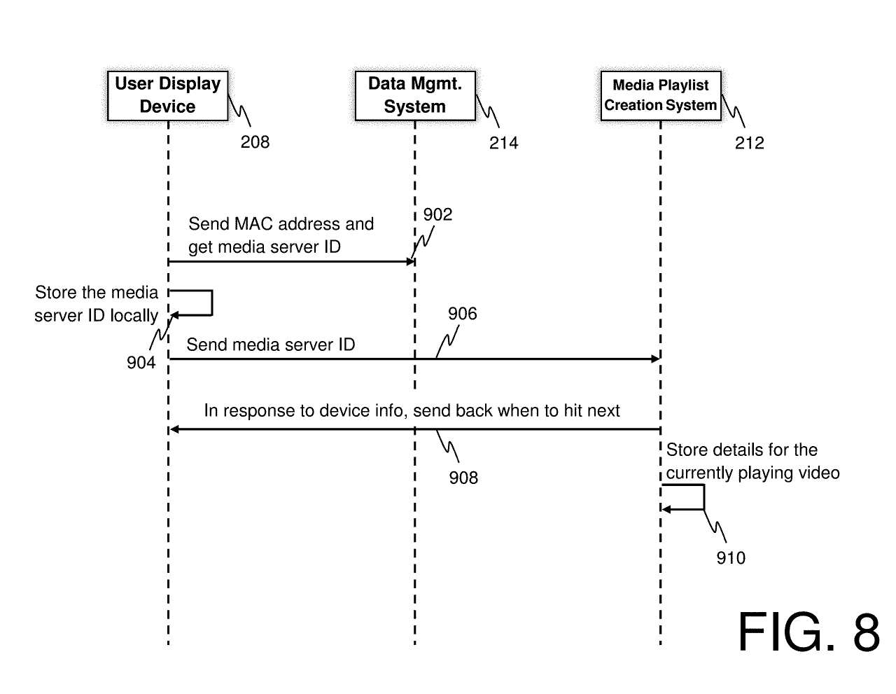

With specific reference to FIG. 8, and in one preferred and non-limiting embodiment or aspect, provided is a process diagram for the communication flow of reporting in the system 200 between the user display device 208, the data management system 214, and the media playlist creation system 212. It will be appreciated that the process may include one or more user display devices 208. At step 902, the user display device 208 sends its MAC address to the data management system 214 and receives a media server 210 ID. At step 904, the user display device stores the media server 210 ID locally. At step 906, the user display device 208 sends the media server 210 ID to the media playlist creation system 212. At step 908, the media playlist creation system 212, in response to receiving the device 208 information, sends back instructions on when to communicate, or “hit,” the media playlist creation system 212 again. At step 910, the media playlist creation system 212 stores the details for the currently broadcasted media, such as the currently playing video. It will be appreciated that other configurations are possible.

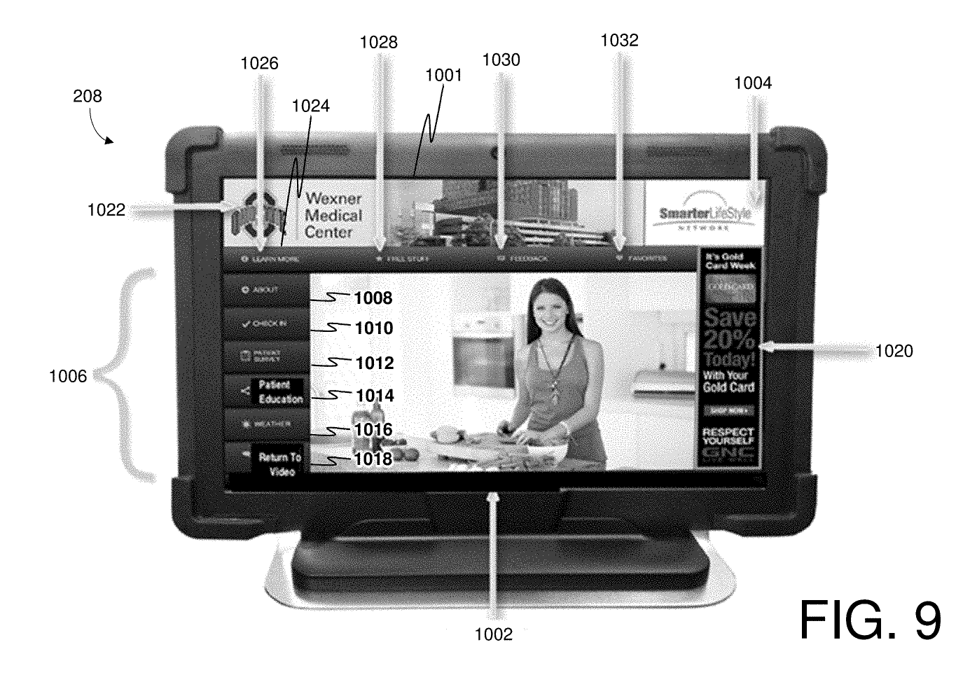

With specific reference to FIG. 9, and in one preferred and non-limiting embodiment or aspect, provided is a mockup of a user display device 208 for use in the system 200. The user display device 208 depicted is a tablet computer, but it will be appreciated that the GUI 1001 therein may be configured for a number of display devices 208, such as smartphones, laptop computers, and/or the like. The GUI 1001 incorporates a wide variety of user friendly functions and unique applications. The GUI 1001 includes a large media box 1002 for displaying primary media content, including broadcast programming, informational videos, consumer surveys, slideshows, and/or the like. The GUI 1001 may also include a picture-in-picture box 1004, which displays the logo of the system provider. The picture-in-picture box 1004 may be used to display video or media content while other media content is being displayed in the large media box 1002. For example, an informational medical program may be displayed in the large media box 1002, and when the user clicks a “Survey” button 1012, the video program is minimized for display in the picture-in-picture box 1004 while the “Survey” content is displayed in the large media box 1002. The picture-in-picture box 1004 may also be configured to return the displayed media content to the large media box 1002 in response to a user action, such as clicking on the picture-in-picture box 1004. It will be appreciated that other configurations are possible.

With further reference to FIG. 9, and in a further preferred and non-limiting embodiment or aspect, the GUI 1001 includes a side menu bar 1006 with one or more interactive buttons for navigating different system content. The side menu bar 1006 may link to a variety of different views, and some preferred and non-limiting exemplary functions are described herein. The side menu bar 1006 may include an “About” button 1008, which may link the user to additional interactive information, which resides on the system provider's server and is used to market the service provider's products and services. The side menu bar 1006 may include a “Check-In” button 1010, which may create an API to aggregate the device's 208 data into the service provider's customer information database, such as a medical service provider's EMR system. The side menu bar 1006 may include a “Survey” button 1012, which provides the user with a survey and the opportunity to share their experience regarding the service provider. When the service provider is a medical service or professional, the “Survey” button 1012 may be a “Patient Survey.” The survey promotes interaction with the service provider staff and allows users to make suggestions that would help enhance their experience in the future. The side menu bar 1006 may include an “Education” button 1014, which may connect the user to a variety of informative, educational topics related to the field of the service provider. When the service provider is a medical service or professional, the topics may be related to health and lifestyle. The side menu bar 1006 may include a “Weather” button 1016, which may open a weather widget that gives the user immediate local weather conditions and other weather-related information. The side menu bar 1006 may also include a “Return to Video” button 1018, which may return the video to the large media box 1002 from the smaller picture-in-picture box 1004. It will be appreciated that other configurations and arrangements are possible.

With further reference to FIG. 9, and in a further preferred and non-limiting embodiment or aspect, the GUI 1001 may include a skyscraper advertisement area 1020 for displaying advertiser content. Various configurations and arrangements are possible, but one preferred and non-limiting position is below the picture-in-picture box 1004. The advertising content displayed in the skyscraper advertisement area 1020 may be updated regularly and refresh periodically. The skyscraper advertisement area 1020 may be configured to provide additional information about the advertising content in response to a user action, such as clicking on the skyscraper advertisement area 1020. The GUI 1001 may also include a venue banner 1022 (also called a “header”), which may be configured to display the name of the service provider's venue where the devices 208 are installed. The venue banner 1022 can be updated or changed at any time by updating the content in the data management system. It will be appreciated that other configurations and arrangements are possible.

With further reference to FIG. 9, and in a further preferred and non-limiting embodiment or aspect, the GUI 1001 may include a top menu bar 1024, preferably located directly under the venue banner 1022 and extending under part of the picture-in-picture box 1004. The top menu bar 1024 may link to a variety of different views, and some preferred and non-limiting exemplary functions are described herein. The top menu bar 1024 may include a “Learn More” button 1026, which may link to one or more pages of interactive content that is assigned to the large media box 1002 for display. These pages may provide users with information about the current video or commercial spot that is playing. The top menu bar 1024 may include a “Free Stuff” button 1028, which may provide the user with a short general survey and, upon completion, provide the user with access to a variety of free targeted offers. The offers may be based upon the user's answers to the survey and can be sent directly to the user's email address or mobile device. The top menu bar 1024 may include a “Feedback” button 1030, which may provide the user with a short survey allowing the user to share some of their information, such as comments, questions, or concerns. The feedback may be used to provide marketing data for advertising clients of the system provider. The top menu bar 1024 may include a “Favorites” button 1032, which may provide the user with access to additional marketing and advertising resources associated with the content that is currently part of the device 208 they are using. Upon selecting any of these resources, the user may be directed or linked to additional information about advertisers and products. The interactive pages and buttons of the GUI 1001 may be customized for the service provider to reflect their services and information needs. For example, for automobile service providers, the GUI 1001 may display available car repair and maintenance services and be tailored to automobile-related content. For salon and beautician services, the GUI 1001 may display a catalog of hair styling options and beauty services. It will be appreciated that other configurations and arrangements are possible.

With specific reference to the foregoing figures, and in further preferred and non-limiting embodiments or aspects, the user display device 208 may comprise an imaging device, e.g., a camera, to capture end user record data that can be used to update the user's record in the system, which may be used to better identify the end user. The user display device 208 may further comprise a geo-location device, e.g., a GPS, to provide location services to the user, such as directing the user to an advertiser's location. It will further be appreciated that the system may contain multiple user display devices that may be one or more type/model of device (e.g., Android tablet computer, Apple tablet computer, Android smartphone, Apple iPhone, etc.), with the media content synchronized across the various devices and types of devices. It will also be appreciated that the system, particularly through the user display device, may be integrated into various other existing systems, devices, applications, and services. For example, the system may be integrated with one or more social media platforms, such that an end user may share material associated with media content. Further, the data displayed to the user and received from the user may be integrated to the service provider's customer information database, to update client data, such as personal information, service history, client needs/wants, etc. The system may comprise a security authentication portal, facilitated through a social media platform or independent thereof, for a user to log in to interactive devices. Furthermore, user email or calendar applications may be integrated either directly or indirectly, such as an end user being able to email themselves coupons, reminders, or material associated with media content. Weather applications may be integrated to provide ongoing weather data for the location of the target setting. It will be appreciated that various other configurations or arrangements are possible.

Although the invention has been described in detail for the purpose of illustration based on what is currently considered to be the most practical and preferred and non-limiting embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. An interactive information presentation system for use by a host service provider and interaction by at least one guest user in a target setting, the system comprising:
a public display device controller programmed or configured to communicate with at least one public display device and cause the at least one public display device to display at least a portion of media content, the media content comprising at least one of the following: video data, audio data, advertisements, host service provider information, regional information, or any combination thereof;
at least one user display device programmed or configured to receive user input and display at least a portion of the media content customized to the at least one user display device;
a media server programmed or configured to receive media content lists, download the media content, and distribute the media content over a local network;
a media playlist creation system comprising a processor and a database configured to communicate and store media content information, respectively, the media content information comprising at least one of the following: links to video assets, data to categorize and identify the media content, media playlist parameters, logs of playback of the media content, or any combination thereof; and
a data management system comprising a processor and a database configured to communicate and store system operation data, respectively, the system operation data comprising at least one of the following: customer data, advertisement data, or any combination thereof.

2. The system of claim 1, further comprising a local networking device programmed or configured to facilitate the local network for intercommunication by the public display device, the at least one user display device, and the media server device, the local networking device being further programmed or configured to provide intercommunication by the media playlist creation system, the data management system, and devices communicating in the local network.

3. The system of claim 2, further comprising a first public display device having at least one data input and being programmed or configured to communicate with the public display device controller.

4. The system of claim 3, wherein the local networking device is programmed or configured to facilitate multicast network traffic for communicating media content to the at least one user display device and the public display device controller for synchronized display to the at least one guest user.

5. The system of claim 1, wherein the at least one user display device is a first user display device and a second user display device, the first user display device being programmed or configured to display the media content customized to a first guest user of the at least one guest user, and the second user display device being programmed or configured to display the media content customized to a second guest user of the at least one guest user.

6. The system of claim 5, wherein the first user display device and the second user display device are different types of devices selected from a first model of tablet computer, a second model of tablet computer, and a smartphone.

7. The system of claim 6, wherein the media content comprises a first set of advertisements customized for display on the first user display device to the first guest user and a second set of advertisements customized for display on the second user display device to the second guest user.

8. The system of claim 1, wherein the at least one user display device and the public display device controller communicate to the data management system data representative of display of and user interaction with the media content by the at least one guest user, and wherein the data management system communicates to a system administrator the data representative of display of and user interaction with the media content.

9. The system of claim 1, wherein the media content comprises at least one video and audio segment, the video and audio segment being selected to represent services provided by the host service provider.

10. The system of claim 1, wherein the data management system is programmed or configured to:
receive a first device identifier and first request for media content from a first user display device of the at least one user display device;
determine an identity of the first user display device based at least partially on the first device identifier;
receive a second device identifier and a second request for media content from the public display device controller;
determine an identity of the public display device controller based at least partially on the second device identifier;
determine the media content for display through the first user display device and the public display device controller;
receive a list of media content and a corresponding playlist from a media playlist creation system and provide the list of media content and the corresponding playlist to the media server for creation of a synchronized multicast data object, comprising the media content and configured to display the media content; and,
in response to determining the media content for display, communicate the media content to the first user display device and the public display device controller, at least partially through a local network, the media content being configured for synchronized display on the first user display device and the at least one public display device to the at least one guest user.

11. An interactive information presentation method for use by a host service provider and interaction by at least one guest user in a target setting, the method comprising:
receiving a first device identifier and first request for media content from at least one user display device, the at least one user display device being programmed or configured to receive user input and display at least a portion of media content;
determining an identity of the at least one user display device based at least partially on the first device identifier;
receiving a second device identifier and a second request for media content from a public display device controller, the public display device controller being programmed or configured to communicate with at least one public display device and cause the at least one public display device to display at least a portion of the media content;
determining an identity of the public display device controller based at least partially on the second device identifier;
determining the media content for display through the at least one user display device and the public display device controller;
receiving a list of media content and a corresponding playlist from a media playlist creation system and providing the list of media content and the corresponding playlist to a media server for creation of a synchronized multicast data object comprising the media content and configured to display the media content; and,
in response to determining the media content for display, communicating the media content to the at least one user display device and the public display device controller, at least partially through a local network, the media content being configured for synchronized display on the at least one user display device and the at least one public display device to the at least one guest user.

12. The method of claim 11, wherein the media content comprises advertisements customized for display to the at least one guest user.

13. The method of claim 12, further comprising:
receiving data representative of display of and user interaction with the media content by the at least one guest user through the at least one user display device and the public display device controller; and
reporting the data to at least one system administrator.

14. The method of claim 13, wherein the media content further comprises at least one video and audio segment, the video and audio segment being selected to represent services provided by the host service provider.

15. The method of claim 14, further comprising communicating the media content to the at least one user display device and the public display device controller indirectly through the media server.

16. An apparatus for an interactive information presentation system of a host service provider supporting at least one guest user in a target setting, the apparatus comprising at least one non-transitory computer-readable medium having program instructions stored thereon that, when executed by at least one processor, cause the at least one processor to:
receive a first device identifier and first request for media content from at least one user display device, the at least one user display device being programmed or configured to receive user input and display at least a portion of media content;
determine an identity of the at least one user display device based at least partially on the first device identifier;
receive a second device identifier and a second request for media content from a public display device controller, the public display device controller being programmed or configured to communicate with at least one public display device and cause the at least one public display device to display at least a portion of the media content;
determine an identity of the public display device controller based at least partially on the second device identifier;
determine the media content for display through the at least one user display device and the public display device controller;
receive a list of media content and a corresponding playlist from a media playlist creation system and provide the list of media content and the corresponding playlist to a media server for creation of a synchronized multicast data object comprising the media content and configured to display the media content; and,
in response to determining the media content for display, communicate the media content to the at least one user display device and the public display device controller, at least partially through a local network, the media content being configured for synchronized display on the at least one user display device and the at least one public display device to the at least one guest user.

17. The apparatus of claim 16, wherein the media content comprises advertisements customized for display to the at least one guest user.

18. The apparatus of claim 17, further causing the at least one processor to:
receive data representative of display of and user interaction with the media content by the at least one guest user through the at least one user display device and the public display device controller; and
report the data to at least one system administrator.

19. The apparatus of claim 18, wherein the media content further comprises at least one video and audio segment, the video and audio segment being selected to represent services provided by the host service provider.

20. The apparatus of claim 19, further causing the at least one processor to communicate the media content to the at least one user display device and the public display device controller indirectly through the media server.
